(19) United States
(12) Patent Application Publication
(10) Pub. No.: US 2009/0173099 A1
(43) Pub. Date: Jul. 9, 2009

(54) Universal Glycol Cooler

(76) Inventor: Igor Grigorovich GUMENNYY, Kharkov (UA)

Correspondence Address: BEEM PATENT LAW FIRM, 53 W. JACKSON BLVD., SUITE 1352, CHICAGO, IL, 60604-3787, US

(21) Appl. No.: 12/343,741

(22) Filed: Dec. 24, 2008

(30) Foreign Application Priority Data
Dec. 27, 2007 (UA) U 2007 14886

(51) Int. Cl. B67D 5/62; F25B 1/00; F28F 3/08

(52) U.S. Cl. 62/389; 62/498; 165/166

(57) ABSTRACT

The applied for technical solution is based on a problem to improve a universal glycol cooler comprising an evaporator, a refrigerating compressor, a drying filter, a throttling device, characterized in that the cooler additionally comprises an air-cooled condenser, high pressure relay, low pressure relay, wherein evaporator is a plate heat exchanger or a direct beer cooler able of controlling the temperature of beverage cooling. Glycol beer cooler permits beer cooling at the exit of dispenser up to −3° C. to −2° C. without any preliminary keg cooling at special refrigerating chambers. The design also permits beer dispensing at product temperatures above zero at dispenser exit. Beer flow rate in this line makes 30100 L/hr in case of continuous dispensing within one hour. Beer cooler permits dispensing of several grades of beer by turns or intermittently. The cooler permits selling even beer that obtained ambient temperature while stored in kegs.

### CROSS-REFERENCE TO RELATED APPLICATIONS

This application claims the benefit of priority from Ukrainian patent application number u 200714886, filed Dec. 27, 2007.

### BACKGROUND OF THE INVENTION

1. Field of the Invention

The present utility relates to a universal glycol cooler.

2. Description of Related Art

Cooling lines are arranged from certain devices. One of the basic elements of a cooling line is a cooling device or cooler that may operate by itself. Various known cooling devices or refrigerating machines differ in both function and design.

Refrigerating machines remove heat from the item to be cooled, thus making its temperature lower than that of environment. Refrigerating machines can produce moderate freeze up to −150° C. Temperatures under this value refer to cryogenic technology. Capacity of refrigerating machines is measured as refrigerating capacity, which may be within the range from several hundred watts (W) to several megawatts (MW).

The basic elements of cooling devices are: evaporators, condensers, throttling devices, which may be operated as such, independent from the system, and for various destinations.

Refrigerating machines are self-contained by themselves, but they may be arranged into, say, a beer cooling line. Thus, if we need to cool process water by seven degrees and we have a source of circulating water, as is the case in large restaurants, it would be sufficient to connect this source to condenser of an auxiliary cooling device, and in this case the basic cooling device becomes redundant. If someone needs to cool process water, or lubricant, or propylene glycol, but a circulating water source is unavailable, then the main cooling device based on air condenser would be sufficient, and auxiliary device is unnecessary. Thus, a certain “Lego” permits to use either of two cooling devices independently from each other, but they are both present in the same process diagram and operate in accordance with particular process needs.

### BRIEF DESCRIPTION OF THE DRAWINGS

FIG. 1 is a universal cooler of the present invention.

FIG. 2 is a perspective view of a heat exchanger shown in FIG. 1.

FIG. 3 is a perspective view of a set of plates for a heat exchanger.

FIG. 4 is a perspective view of a heat exchanger that operates in counter-flow mode using the set of plates shown in FIG. 3.

FIG. 5 is a perspective view of a thermal regulating valve.

FIG. 6 is a perspective view of a high-pressure relay.

### DETAILED DESCRIPTION OF THE INVENTION

The closest prior art to the proposed solution is keg beer cooling device (Ukrainian Patent 29972 of Feb. 11, 2008) comprising an evaporator, refrigerating compressor, condenser, propylene glycol tub with an immersed tubular evaporator, characterized in that it additionally comprises a plate-type heat exchanger, thermal regulating valve and a separate isolated vessel (instead of tub) with an immersed tubular evaporator for propylene glycol (whereas the plate-type heat exchanger is soldered).

The prior art has some drawbacks. Prior art cooler cools not the product directly, but propylene glycol, which in turn cools the final product—beer. Thus, heat exchangers for beer are not envisaged. The prior art cannot regulate the product temperature at cooler exit and does not enable sale of cooled beer at unaccommodated places (fairs, summer outlets, etc.)

Thus, the applied for technical solution is based on a problem to improve a universal glycol cooler comprising an evaporator, a refrigerating compressor, a drying filter, a throttling device, characterized in that the cooler additionally comprises an air-cooled condenser, high pressure relay, low pressure relay, wherein evaporator is a plate heat exchanger or a direct beer cooler able of controlling the temperature of beverage cooling.

Universal glycol cooler provides cooling of beer sold on tap at cafes, bars, restaurants and other catering outlets.

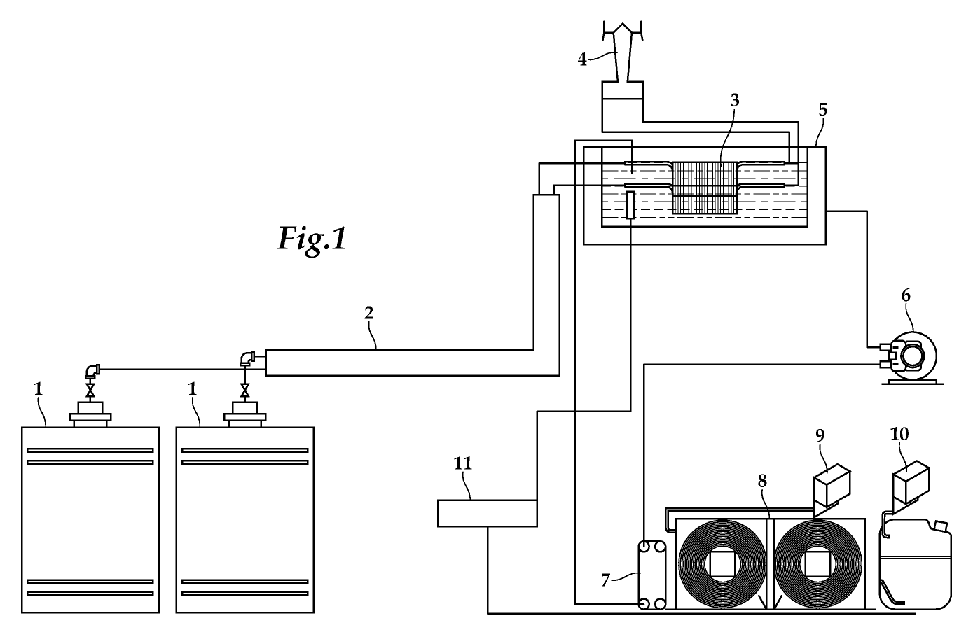

Glycol beer cooler permits beer cooling at the exit of dispenser up to −3° C. to −2° C. without any preliminary keg cooling at special refrigerating chambers. The design also permits beer dispensing at product temperatures above zero at dispenser exit. Beer flow rate in this line makes 30100 liters/hour (L/hr) in case of continuous dispensing within one hour. Beer cooler permits dispensing of several grades of beer by turns or intermittently. FIG. 1 shows two grades of beer. The cooler permits selling even beer that obtained ambient temperature while stored in kegs.

### Advantages of the Universal Cooler

Such features of universal cooler are advantageous:

a single cooler in the cooling line, which saves space under bar stand or at beer line installation place due to modest dimensions of the unit;

stable maintenance of temperature below zero at the exit without any preliminary cooling of product;

capability to obtain different temperatures at dispenser exit which helps to preserve the whole set of taste sensations of the product as recommended by brewers, at temperatures below or above zero;

possibility to install a heating element in glycol bath to heat beer in the process of dispensing under low ambient temperatures;

prevention of residual product freezing at heat exchanger after dispensing was finished, as direct contact between freon loop and beer is absent, as distinct from dry-type coolers that can give only temperature above zero at the exit;

regulation of condensation temperature; and

possibility to cool two beer grades up to temperatures below zero.

As evident from the description of technical essence, the proposed solution possesses substantial differences from the prior art, thus, it has novelty. The applied for utility is industrially realizable and can be manufactured at a specialized facility.

Refrigerating machine may be installed at summer places and is able of operating at ambient temperatures +12° C. to +32° C., that is, in tropical option, with regulated condensation temperature, due to application of condenser air blowing fan and high-pressure relay, or by regulation of fan motor frequency.

### Design and Operation of Universal Cooler

Beer cooling line is shown in FIG. 1. Beer is fed from kegs (1) along beer delivery line (2) insulated from ambient heat to heat exchanger (3). Insulation of beer delivery line (2) is necessary in case the temperature of beer in kegs is lower than ambient temperature. Heat exchanger (3) is immersed into tub of aqueous solution of propylene glycol (5), its temperature being maintained at the level −4° C. to −3° C. Beer is cooled at heat exchanger (3) due to heat exchange between coolant, i.e. propylene glycol circulating in tub (5), and beer that comes through and gives its heat to the circulating propylene glycol. Then the beer cooled to desirable temperature is fed to dispenser (4).

Propylene glycol circulates due to pump (6). Propylene glycol from tub (5) is fed to soldered plate heat exchanger (7), which forms evaporator of refrigerating machine, cooled there to necessary temperature and returned to tub (5).

The necessary temperature of cooled propylene glycol is monitored by controller (11) of refrigerating machine, its sensor being immersed directly to propylene glycol tub (5); the same controller controls operation of refrigerating machine.

Refrigerating machine comprises, on a par with compressor, drying filter and throttling device: air-cooling condenser (8); high-pressure relay (9); low-pressure relay (10); evaporator represented by soldered plate heat exchanger (7).

Refrigerating machine cools circulating propylene glycol up to temperature necessary to maintain prescribed beer temperature at dispenser exit.

### Elements of Universal Cooler

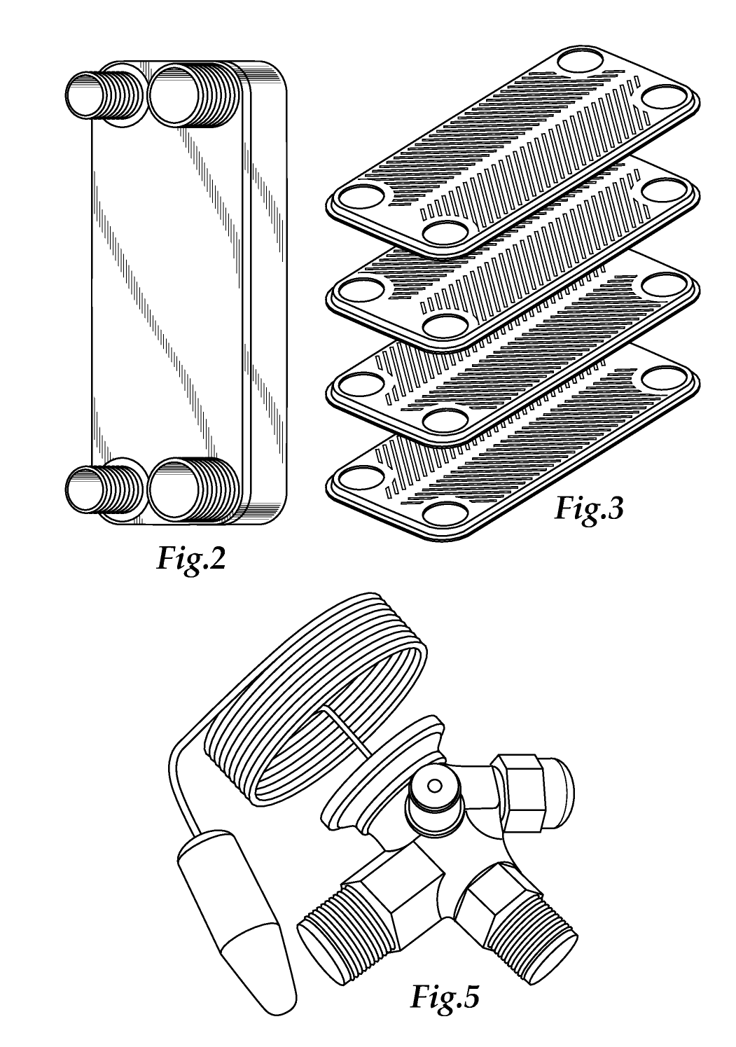

To cool propylene glycol up to temperature necessary to maintain prescribed beer temperature at dispenser exit at the level of −3° C. to −2° C. a soldered plate heat exchanger is proposed, as shown in FIG. 2. This heat exchanger design serves for direct cooling of coolants, in our case of propylene glycol.

The main advantage of this type of heat exchanger is high thermal performance under small dimensions, high thermal capacity and extremely efficient heat exchange.

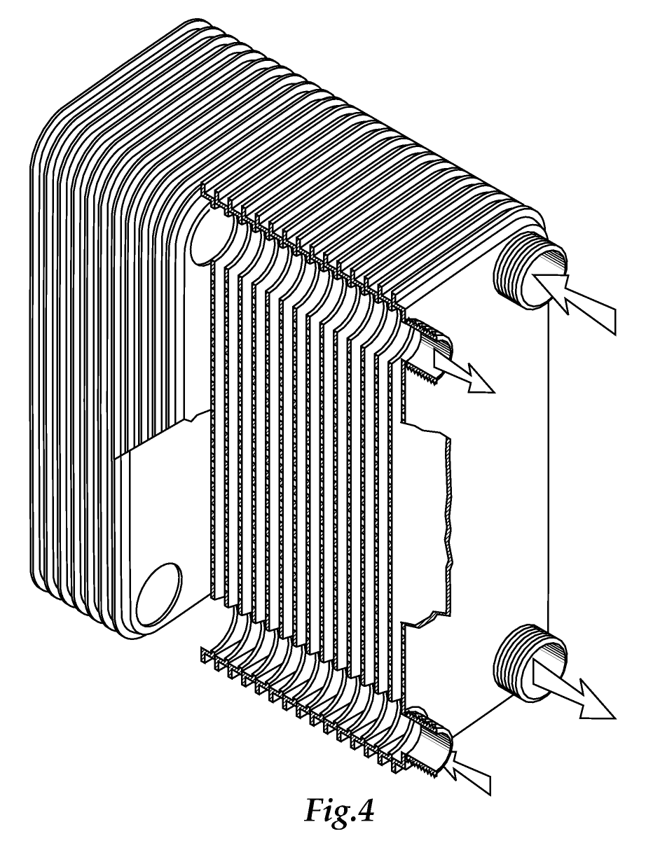

This design of heat exchanger is the best of those commercially available at the moment. The heat exchanger comprises a set of plates, as shown in FIG. 3, made of stainless steel and soldered with copper solder. Each plate has its own relief of channels for flow of media, their sum forming the heat exchange surface. Heat exchange between media in this unit operates in counter-flow mode, as shown in FIG. 4.

Similar heat exchangers are not widely used in traditional propylene glycol coolers at beer cooling lines due to the fact that traditional designs admit precooling of beer at special refrigerating chambers and do not possess a comparable cooling capacity.

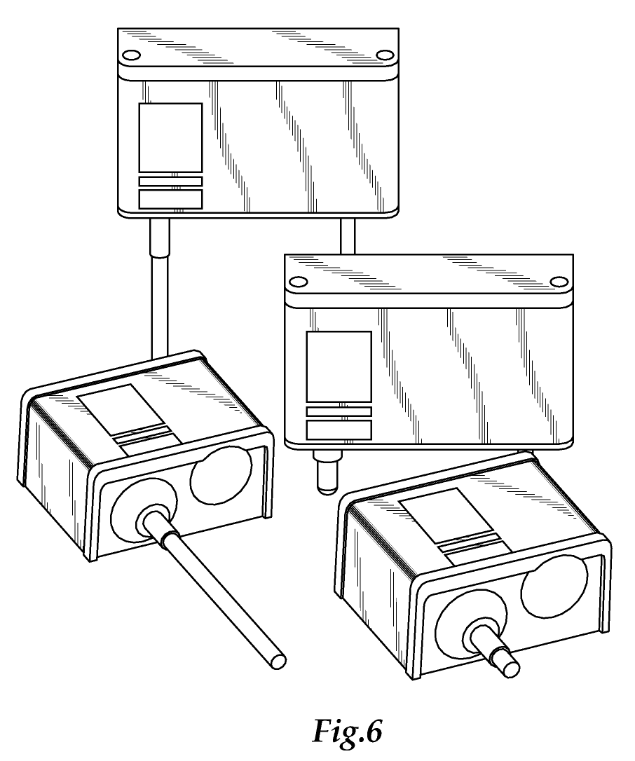

The function of refrigerating machine throttling device is proposed for thermal regulating valve, as shown in FIG. 5. The valve serves to maintain constant heating temperature in the cooling loop, which in turn permits efficient cooling cycle under actual conditions. The constant heating temperature in the cooling loop is maintained by regulation of liquid freon delivery to evaporator irrespective of its thermal loading. The thermal regulating valve controls freon filling of the evaporator in an automatic mode. If necessary, this valve may be adjusted manually.

Such coolers are usually equipped with a constant section capillary pipe. Due to constant internal section of the capillary pipe the evaporator is filled with a constant quantity of freon and flow section of the valve varies in accordance with evaporator thermal loading, which ensures constant freon filling of the evaporator.

Refrigerating machine is equipped with low pressure and high-pressure relays. Those instruments are shown in FIG. 6 (pressure relay). High-pressure relay maintains prescribed condensation temperature by controlling the motor of condenser blowing fan. Pressure relay capillary pipe is soldered directly into cooling loop liquid line and adjusted to the necessary condensation temperature. If condensation temperature is under the prescribed value (suppose, the line is installed at a summer site and ambient temperature on an August evening is 15° C.), a reduced condensation temperature leads to decreased condensation pressure, the pressure relay denotes this and switches off the condenser fan motor, thus bringing to a normal increase of condensation temperature. When ambient temperature and, accordingly, condensation temperature rises, condensation pressure in the cooling loop increases, the pressure relay denotes this and switches on the condenser fan motor, thus bringing to a normal decrease of condensation temperature.

In this way a stable condensation temperature corridor is created which is maintained by high-pressure relay, thus ensuring stable operation of air condenser at ambient temperatures varying within the limits 12° C. to 32° C. and, consequently, stable operation of refrigerating machine under such conditions.

Similar regulation of condensation temperatures is not used in traditional coolers. Low-pressure relay is necessary for emergency disconnection of refrigerating machine in case the delivery of propylene glycol to the evaporator discontinues by some reason (say, glycol leak or failure of circulation pump). When the delivery of propylene glycol to the evaporator discontinues, the boiling temperature is reduced as well as boiling pressure, the pressure relay denotes this, switches off the whole refrigerating machine and precludes its emergency restart until the failure is corrected. An immersion pump is used for propylene glycol circulation.

Thus, the proposed solution has some substantial advantages as compared to prior art; it is able to solve the problem of development and improvement of a beer cooling line operable under stable conditions or susceptible to correction depending on the amount and grade of beer as well as under varying beer cooling temperature.

What is claimed:

1. A universal glycol cooler for controlling the temperature of a fluid, the cooler comprising:
at least one first evaporator,
a refrigerating compressor, a drying filter, and a throttling device operatively coupled to the at least one first evaporator, and
a refrigerating machine comprising
at least one second evaporator,
an air-cooled condenser coupled to the at least one second evaporator,
a high pressure relay coupled to the condenser, and
a low pressure relay coupled to the high pressure relay.

2. A universal glycol cooler according to claim 1, wherein the at least one first evaporator is a plate heat exchanger, wherein the plate heat exchanger comprises a plurality of plates coupled together, wherein each of the plurality of plates has at least one channel configured to channel fluid therethrough.

3. A universal glycol cooler according to claim 1, wherein the at least one first evaporator is a fluid heat exchanger for direct cooling of the fluid.

4. A universal glycol cooler according to claim 3, wherein the fluid heat exchanger is at least one of a beer heat exchanger and a beverage heat exchanger.

5. A universal glycol cooler according to claim 1, wherein the fluid is at least one of a beverage and a beer.

6. A universal glycol cooler according to claim 1, wherein the refrigerating machine further comprises at least one controller comprising at least one sensor.

7. A universal glycol cooler according to claim 1, wherein the at least one second evaporator is a soldered plate heat exchanger, wherein the soldered plate heat exchanger comprises a plurality of plates coupled together, wherein each of the plurality of plates has at least one channel configured to channel fluid therethrough.

8. A universal glycol cooler according to claim 1, wherein the at least one first evaporator is coupled at least partially within a tub, wherein the tub includes a solution of propylene glycol.

9. A universal glycol cooler according to claim 8, further comprising a pump operatively coupled to at least one of the tub and the solution of propylene glycol.

10. A universal glycol cooler according to claim 8, further comprising a fluid delivery line operatively coupled to the tub.

11. A universal glycol cooler according to claim 10, further comprising at least one keg coupled to the fluid delivery line.

12. A universal glycol cooler according to claim 11, wherein the fluid delivery line is configured to continuously dispense beer at a beer flow rate of about 30,100 liters per hour.

13. A universal glycol cooler according to claim 8, further comprising a dispenser operatively coupled to at least one of the tub and the at least one first heat exchanger, wherein the dispenser is configured to dispense the fluid such that the temperature of the fluid is between −3° C. to −2° C.

14. A universal glycol cooler according to claim 13, wherein the dispenser is configured to dispense the fluid such that the temperature of the fluid is greater than 0° C.

15. A universal glycol cooler according to claim 13, wherein the dispenser is configured to dispense the fluid without preliminary keg cooling in refrigerating chambers.

16. A universal glycol cooler according to claim 1, wherein the at least one first evaporator is configured to operate in a counter-flow mode.

17. A universal glycol cooler according to claim 1, wherein the at least one second evaporator is configured to operate in a counter-flow mode.

18. A universal glycol cooler according to claim 1, wherein the at least one second evaporator is configured to operate in a counter-flow mode.

19. A universal glycol cooler according to claim 1, wherein the cooler is configured to intermittently dispense a plurality of fluids.
